(19) United States
(12) Patent Application Publication
(10) Pub. No.: US 2025/0273895 A1
(43) Pub. Date: Aug. 28, 2025

(54) CONNECTOR AND CONNECTOR DISASSEMBLY TOOL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Yasunori ASANO, Mie (JP)

(21) Appl. No.: 18/856,885

(22) PCT Filed: Apr. 10, 2023
(86) PCT No.: PCT/JP2023/014510

§ 371 Date: Oct. 15, 2024

(30) Foreign Application Priority Data
Apr. 22, 2022 (JP) 2022-070541

(51) Int. Cl. H01R 13/436; H01R 43/22

(52) U.S. Cl. CPC H01R 13/4361; H01R 43/22

(57) ABSTRACT

A connector includes a terminal and a connector housing including a housing body having a cavity and a retainer to be removably mounted into the housing body, the terminal being accommodated into the cavity. The housing body includes a cavity exposing recess for exposing an intermediate part in an extension direction of the cavity to outside and a pair of locking portions formed on both side parts of the housing body. The retainer includes a retainer body for holding the terminal in the cavity, a pair of retainer side portions extending from both side parts of the retainer body toward the pair of locking portions and a pair of mating locking portions respectively formed on the pair of retainer side portions and lockable to the locking portions. A dividing recess recessed in the extension direction of the cavity is formed in each of the pair of retainer side portions.

### TECHNICAL FIELD

The present disclosure relates to a connector and a connector disassembly tool.

### BACKGROUND

Patent Document 1 discloses a terminal pull-out jig used for a connector including an upper terminal held by a lance mechanism and upper and lower guide projections located closer to an opening side than the upper terminal. The terminal pull-out jig includes a jig body and a release pin. It is disclosed to release the lance mechanism by inserting a tip side of the jig body into an outer housing of the connector and turning the release pin facing the lance mechanism about a center axis of the jig body.

### PRIOR ART DOCUMENT

### Patent Document

Patent Document 1: JP 2018-170108 A

### SUMMARY OF THE INVENTION

### Problems to be Solved

There is known a connector in which a retainer is mounted into a housing body and a terminal is held by this retainer. Also in the connector in which the terminal is held by the retainer in this way, it is requested to make a state of holding the terminal by the retainer easily releasable.

Accordingly, the present disclosure aims to make a state of holding a terminal by a retainer easily releasable.

### Means to Solve the Problem

The present disclosure is directed to a connector with a terminal and a connector housing including a housing body having a cavity extending from one end toward the other end and a retainer to be removably mounted into the housing body, the terminal being accommodated into the cavity, the housing body including a cavity exposing recess for exposing an intermediate part in an extension direction of the cavity to outside and a pair of locking portions formed on both side parts of the housing body, the retainer including a retainer body to be arranged in the cavity exposing recess to hold the terminal in the cavity, a pair of retainer side portions extending from both side parts of the retainer body toward the pair of locking portions and a pair of mating locking portions respectively formed on the pair of retainer side portions and lockable to the locking portions, and a dividing recess recessed in the extension direction of the cavity is formed in each of the pair of retainer side portions.

Further, the present disclosure is directed to a connector disassembly tool for releasing a locked state of a retainer to a housing body, the connector disassembly tool being provided with a pair of dividing blades and a disassembly tool body for supporting the pair of dividing blades such that the pair of dividing blades are held in parallel while being spaced apart by a distance corresponding to a width between a pair of locking parts of the retainer to both side parts of the housing body.

### Effect of the Invention

According to the present disclosure, a state of holding a terminal by a retainer can be easily released.

### BRIEF DESCRIPTION OF THE DRAWINGS

FIG. 1 is a perspective view showing a connector according to an embodiment.

FIG. 2 is a perspective view showing the connector having a retainer removed therefrom.

FIG. 3 is a section along III-III of FIG. 1.

FIG. 4 is a section along IV-IV of FIG. 1.

FIG. 5 is a perspective view showing a connector disassembly tool.

FIG. 6 is a perspective view in section along VI-VI of FIG. 5.

FIG. 7 is a view showing a disassembly operation.

FIG. 8 is a diagram showing a dividing operation by a dividing blade.

FIG. 9 is a diagram showing the dividing operation by the dividing blade.

### DETAILED DESCRIPTION TO EXECUTE THE INVENTION

### Description of Embodiments of Present Disclosure

First, embodiments of the present disclosure are listed and described.

The connector of the present disclosure is as follows.

(1) The connector of the present disclosure is provided with a terminal and a connector housing including a housing body having a cavity extending from one end toward the other end and a retainer to be removably mounted into the housing body, the terminal being accommodated into the cavity, the housing body including a cavity exposing recess for exposing an intermediate part in an extension direction of the cavity to outside and a pair of locking portions formed on both side parts of the housing body, the retainer including a retainer body to be arranged in the cavity exposing recess to hold the terminal in the cavity, a pair of retainer side portions extending from both side parts of the retainer body toward the pair of locking portions and a pair of mating locking portions respectively formed on the pair of retainer side portions and lockable to the locking portions, and a dividing recess recessed in the extension direction of the cavity is formed in each of the pair of retainer side portions.

According to this connector, the retainer side portions can be easily divided, utilizing the dividing recesses. By dividing the retainer side portions, the retainer can be moved in a direction separating from the housing body. In this way, a state of holding the terminal by the retainer is easily released and the terminal is easily separated from the housing body.

(2) In the connector of (1), the dividing recess may be formed into a V shape recessed from at least one of edges of the retainer side portion on one end side and the other end side of the housing body.

In this way, a dividing blade is easily guided to a fixed position of the dividing recess recessed into a V shape. In this way, the retainer side portion is easily and stably divided.

(3) In the connector of (1) or (2), the dividing recesses may be formed in the both edges of the retainer side portion on the one end side and the other end side of the housing body.

In this case, since the retainer side portion can be divided from either one of the edges of the retainer side portion on the one end side and the other end side of the housing body, utilizing the dividing recess, workability is excellent.

(4) In the connector of any one of (1) to (3), a recessed groove extending from a position where the dividing recess is arranged to at least one of one end and the other end of the housing body may be formed in each of the both side parts of the housing body.

In this way, the dividing blade can cut into the dividing recess by being moved along the recessed groove. In this way, an operation of dividing the retainer side portion can be easily and stably performed.

(5) In the connector of (4), the recessed groove may have a side surface facing a tip of the retainer side portion and extending along the extension direction of the cavity, and the side surface may be formed at a position spaced apart from the tip of the retainer side portion.

In this case, after the dividing blade cuts into the retainer side portion, a divided part moves to fill a gap, whereby the dividing blade enters between the divided parts of the retainer side portion. Thus, the retainer side portion can be easily divided.

(6) In the connector of any one of (1) to (5), the housing body may have a principal surface located on an extension of an outward facing surface of the retainer body and a pair of side surfaces located on extensions of outward facing surfaces of the pair of retainer side portions in a mounted state of the retainer.

In this way, a connector disassembly tool for removing the retainer is easily handled outside the principal surface and the pair of side surfaces.

Further, the connector disassembly tool of the present disclosure is as follows.

(7) The connector disassembly tool is for releasing a locked state of a retainer to a housing body, and provided with a pair of dividing blades and a disassembly tool body for supporting the pair of dividing blades such that the pair of dividing blades are held in parallel while being spaced apart by a distance corresponding to a width between a pair of locking parts of the retainer to both side parts of the housing body.

According to this connector disassembly tool, the pair of dividing blades can be moved to the pair of locking parts or parts near the locking parts along the both side parts of the housing body. A state of holding a terminal can be released by dividing the pair of locking parts or the parts near the locking parts of the retainer by the pair of dividing blades and moving the retainer in a direction separating from the housing body.

(8) In the connector disassembly tool of (7), the pair of dividing blades may be exchangeably supported on the disassembly tool body.

In this way, the dividing blade can be exchanged such as when the dividing blade is worn.

(9) In the connector disassembly tool of (7) or (8), the disassembly tool body may be formed into a shape to surround at least a part of a periphery of the housing body while avoiding interference with the housing body when the pair of dividing blades move along the both side parts of the housing body.

In this way, the pair of dividing blades are easily collectively moved toward the pair of locking parts or the parts near the locking parts. An operation of collectively dividing the pair of locking parts or the parts near the locking parts of the retainer by the pair of dividing blades can be easily performed.

(10) The connector disassembly tool of any one of (7) to (9) may be further provided with a grip portion projecting from the disassembly tool body.

In this way, since a force is easily applied to the connector disassembly tool, a disassembly operation of the connector can be easily performed.

### Details of Embodiment of Present Disclosure

Specific examples of a connector and a connector disassembly tool of the present disclosure are described below with reference to the drawings. Note that the present disclosure is not limited to these illustrations, but is represented by claims and intended to include all changes in the scope of claims and in the meaning and scope of equivalents.

### Embodiment

Hereinafter, after a connector according to an embodiment is described, a connector disassembly tool for disassembling the connector is described.

### <Connector>

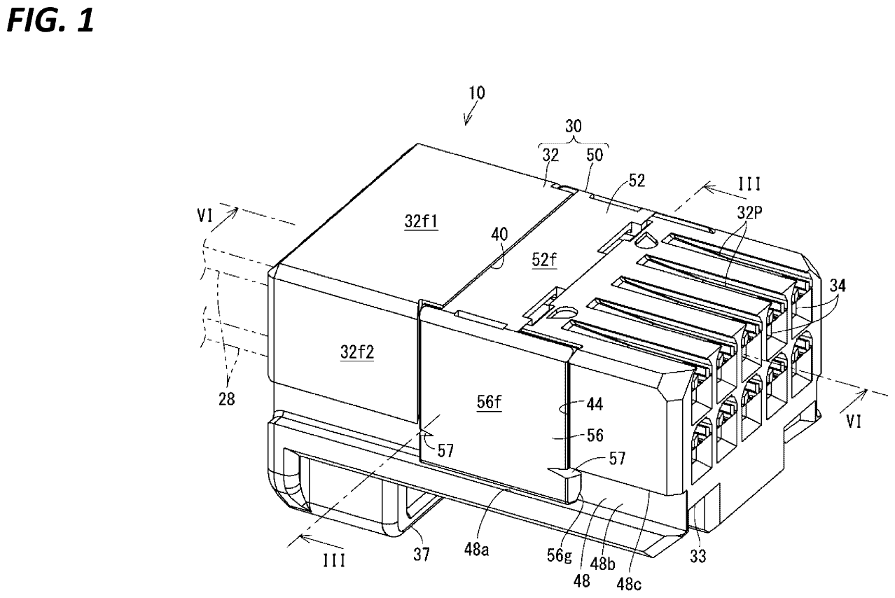

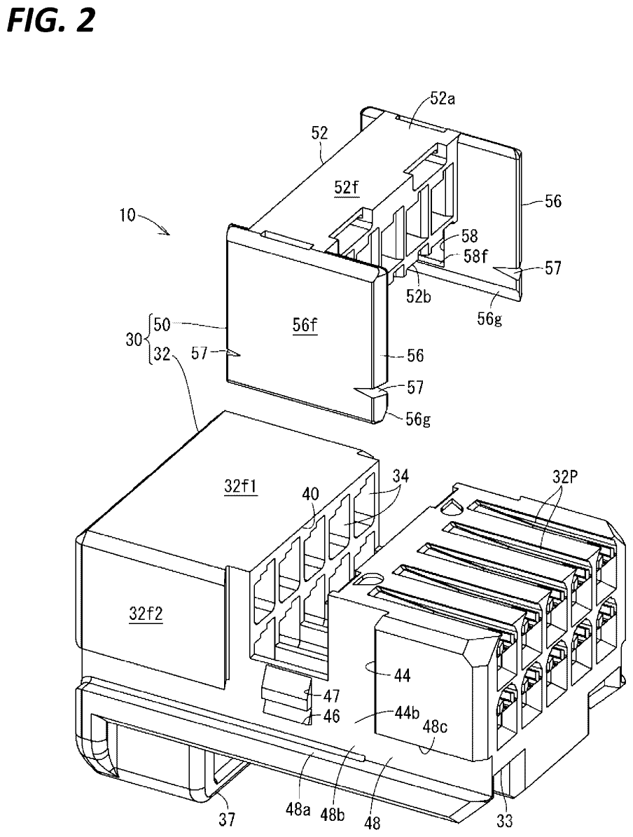

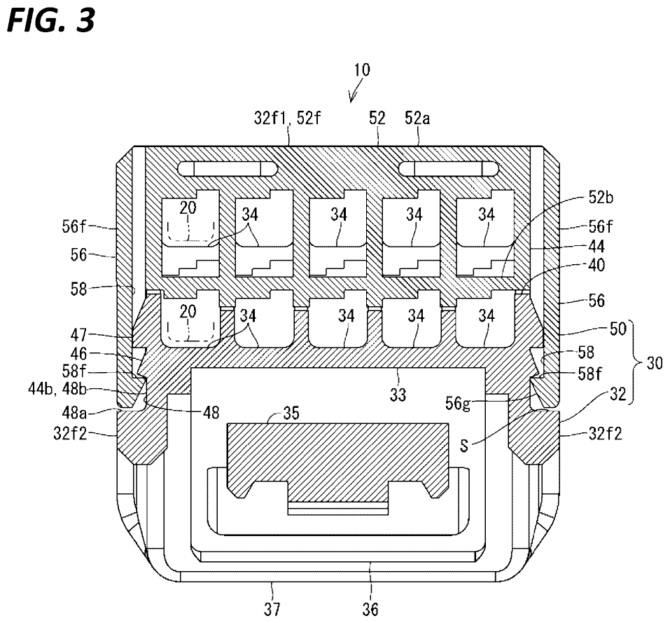

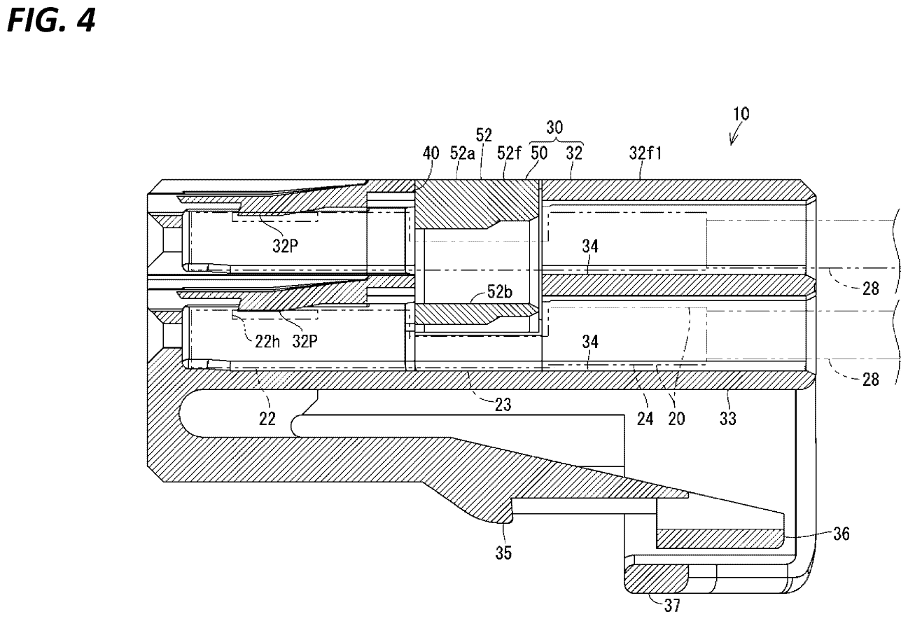

FIG. 1 is a perspective view showing a connector 10. FIG. 2 is a perspective view showing the connector 10 having a retainer 50 removed therefrom. FIG. 3 is a section along III-III of FIG. 1. FIG. 4 is a section along IV-IV of FIG. 1. In FIGS. 1, 3 and 4, some terminals 20 and some wires 28 are shown by two-dot chain lines.

The connector 10 is provided with the terminals 20 and a connector housing 30.

The terminal 20 is formed, such as by press-working a metal plate material of copper, copper alloy or the like. The terminal 20 is formed such that a mating connecting portion 22 and a wire connecting portion 24 are linearly connected via a coupling portion 23 (see FIG. 4).

The mating connecting portion 22 is a part to be connected to a mating terminal or the like. Here, the mating connecting portion 22 has a rectangular tube shape, i.e. a so-called female terminal shape. A mating terminal (so-called male terminal) including a pin-like or tab-like connecting portion is inserted and connected to this mating connecting portion 22. Of course, the mating connecting portion 22 may be formed to have a pin-like or tab-like shape, i.e. a so-called male terminal shape. In the case of a male terminal, a box portion is formed in a base end part of a pin-like or tab-like part.

The wire connecting portion 24 is a part to be crimped to an end part of the wire 28 and connected to the wire 28. The wire connecting portion 24 includes, for example, a core wire crimping portion and a coating crimping portion. Of course, the coating crimping portion may be possibly omitted in the wire connecting portion 24.

The core wire crimping portion is shaped such that a pair of crimping pieces rise from both side parts of a bottom plate portion. The pair of crimping pieces are bent inward with a core wire exposed in the end part of the wire 28 disposed in the core wire crimping portion. In this way, the core wire crimping portion is crimped to the exposed core wire.

The coating crimping portion is also shaped such that a pair of crimping pieces rise from both side parts of a bottom plate portion, and the pair of crimping pieces are bent inward with an end part of an insulation coating of the wire 28 disposed in the coating crimping portion. In this way, the coating crimping portion is crimped to the end part of the insulation coating.

A bottom part of the mating connecting portion 22 and that of the wire connecting portion 24 are coupled via the coupling portion 23. Thus, the bottom part of the mating connecting portion 22, the coupling portion 23 and the bottom part of the wire connecting portion 24 are connected on the same straight line. The mating connecting portion 22 and the wire connecting portion 24 project from the coupling portion 23. In other words, the terminal 20 is shaped to be recessed toward a bottom side between the mating connecting portion 22 and the wire connecting portion 24. By fitting the retainer 50 into a recess between the mating connecting portion 22 and the wire connecting portion 24, the terminal 20 can be held at a fixed position in the connector housing 30.

The connector housing 30 includes a housing body 32 and the retainer 50.

The housing body 32 is a component including cavities 34 extending from one end toward the other end and configured to accommodate the terminals 20 in the cavities 34. The housing body 32 is a component molded, using a resin or the like. With the terminals 20 accommodated in the housing body 32, the connector housing 30 is connected to a mating connector (not shown). In this way, the terminals 20 are connected to the mating terminals accommodated in the mating connector.

More specifically, the housing body 33 includes a flat rectangular parallelepiped part 33. The cavities 34 are formed to extend from one end toward the other end of the rectangular parallelepiped part 33. The cavity 34 is a through hole open in the one end and the other end of the rectangular parallelepiped part 33. The cavity 34 is longer than the terminal 20, and the entire terminal 20 in an extension direction is accommodated in the cavity 34. The wire 28 is pulled out from an opening on the one end side of the cavity 34. The mating terminal is inserted through an opening on the other end side of the cavity 34. For the convenience of description, a side of the connector 10 where the wires 28 extend out and an opposite side thereof may be referred to as a rear side and a front side.

In this embodiment, the housing body 32 includes a plurality of the cavities 34. The plurality of cavities 34 are formed side by side in parallel from one side to the other side of the housing body 32 (here, the rectangular parallelepiped part 33) in a plurality of rows (two rows in this embodiment). Here, a direction orthogonal to an extension direction of the plurality of cavities 34 and an arrangement direction of the plurality of cavities 34 is grasped as a thickness direction of the housing body 32. The respective rows of the plurality of cavities 34 are arranged at positions different in the thickness direction of the housing body 32. By accommodating the terminals 20 respectively into the plurality of cavities 34, a plurality of the terminals 20 are held side by side in parallel. A plurality of cavities may be formed side by side in a row in the housing body 32.

The retainer 50 is removably mounted into the housing body 32. The retainer 50 is removably mounted on one surface side in the thickness direction of the housing body 32.

Note that, in this embodiment, the housing body 32 is provided with a connector connecting locking piece 35 removably locked to the mating connector (see FIGS. 3 and 4). The connector connecting locking piece 35 is provided on a side opposite to the retainer 50 with respect to the rectangular parallelepiped part 33.

Further, the housing body 32 is provided with an operating portion 36 for pushing down the connector connecting locking piece 35 and a surrounding portion 37 surrounding the operating portion 36 (see FIGS. 3 and 4).

With this connector 10 connected to the mating connector, the connector connecting locking piece 35 is locked to the mating connector to maintain a connected state of the both connectors. Further, by pushing down the operating portion 36 in this state, a locked state of the connector connecting locking piece 35 and the mating connector is released and a connected state of the both connectors is released. The surrounding portion 37 functions to suppress the connector connecting locking piece 35 from being inadvertently pushed down by surrounding the operating portion 36.

The connector connecting locking piece 35, the operating portion 36 and the shape example of the operating portion 36 in the connector 10 need not be those described above or these components may be omitted.

The housing body 32 includes a cavity exposing recess 40 and a pair of locking portions 46.

The cavity exposing recess 40 is a recess for exposing intermediate parts in the extension direction of the cavities 34 to outside. In this embodiment, the cavity exposing recess 40 is open on one surface side in the thickness direction of the rectangular parallelepiped part 33. The cavity exposing recess 40 also extends in the arrangement direction of the plurality of cavities 34. Further, the cavity exposing recess 40 extends in a direction intersecting (here, a direction orthogonal to) the extension direction of the plurality of cavities 34 and crosses the intermediate parts in the extension direction of the cavities 34. Since the plurality of cavities 34 are arranged in a plurality of rows (here, two rows) in this embodiment, a depth of the cavity exposing recess 40 is set in a size to cross the intermediate parts in the extension direction of the cavities 34 in the plurality of rows. Thus, the insides of longitudinal intermediate parts of the plurality of cavities 34 can be exposed to the one surface side in the thickness direction of the rectangular parallelepiped part 33. The cavity exposing recess 40 is positioned in a part where the coupling portions 23 are arranged with the terminals 20 accommodated in the cavities 34. Thus, recessed parts of the terminals 20 between the mating connecting portions 22 and the wire connecting portions 24 can be exposed to outside through the cavity exposing recess 40.

Note that an opening 34a on one end of the cavity 34 is shaped to retain the terminal 20 by making an opening smaller than in the intermediate part (see FIG. 4). The terminal 20 is suppressed from coming out from the opening 34a on the one end of the cavity 34 by the contact of a tip part of the terminal 20 with the opening 34a. Further, the housing body 32 includes resilient locking pieces 32P for locking the mating connecting portions 22 of the terminals 20. The resilient locking piece 32P is an elongated resilient deforming piece resiliently deformable inward and outward of the cavity 34, and a tip part thereof is configured to be lockable to a locking hole 22h formed in the mating connecting portion 22 (see FIG. 4). Such a resilient locking piece 32P is a part, which may be called a locking lance.

The position of the terminal 20 in the cavity 34 is restricted by the contact of the terminal 20 with the opening 34a and the locking of the resilient locking piece 32P to the locking hole 22h formed in the mating connecting portion 22.

The pair of locking portions 46 are formed on both side parts of the housing body 32. In this embodiment, a pair of retainer guide grooves 44 are formed in the both side parts of the housing body 32 and the pair of locking portions 46 are formed on bottom surfaces 44b of the pair of retainer guide grooves 44.

The pair of retainer guide grooves 44 are grooves formed in the both side parts of the housing body 32 to extend in a direction intersecting the extension direction of the cavities 34 from both side parts of the cavity exposing recess 40. In this embodiment, the retainer guide groove 44 is a recessed groove extending in a direction orthogonal to both the extension direction of the cavities 34 and the arrangement direction of the plurality of cavities 34 in the side part of the housing body 32. The retainer guide groove 44 does not penetrate through the housing body 32 in the thickness direction.

In this embodiment, the locking portion 46 is formed at a position closer to a tip side of the retainer guide groove 44 than the bottoms of the cavities 34 on the bottom surface 44b of the retainer guide groove 44. In this embodiment, the locking portion 46 is a locking protrusion. A surface of the locking portion 46 on the side of the cavity exposing recess 40 is formed into a guide surface gradually increasing a height of the locking portion 46 with distance from the cavity exposing recess 40. A surface of the locking portion 46 on a side opposite to the cavity exposing recess 40 is formed into a contact surface having a larger angle (nearly a right angle) to the side surface of the housing body 32 than the guide surface. In this way, a retainer side portion 56 (to be described later) of the retainer 50 easily rides over the guide surface and is easily kept locked to the contact surface. Note that, separately from the pair of locking portions 46, auxiliary locking portions 47 may be provided on a side closer to the cavity exposing recess 40. The auxiliary locking portions 47 may be, for example, locked to mating locking portions 58 in a state before the mating locking portions 58 are locked to the locking portions 46.

A pair of recessed grooves 48 are formed to extend at least toward one end part of the housing body 32 from positions of the housing body 32 where the pair of locking portions 46 are respectively formed. In this embodiment, the recessed groove 48 is formed to reach the both ends of the housing body 32. The recessed groove 48 is continuously shaped to have a constant width in an extension direction thereof.

Since the recessed groove 48 passes through the position where the locking portion 46 is formed, the retainer guide groove 44 intersects an intermediate part in the extension direction of the recessed groove 48. Thus, an intersecting part of the intermediate part in the extension direction of the recessed groove 48 and the tip part of the retainer guide groove 44 is a part of the recessed groove 48 and also a part of the retainer guide groove 44.

A bottom surface 48b of the recessed groove 48 and the bottom surface 44b of the retainer guide groove 44 are located on the same plane. An intermediate part in the extension direction of the bottom surface 48b of the recessed groove 48 and a tip part of the bottom surface 44b of the retainer guide groove 44 are the same surface. If a dividing blade 70 to be described later is moved along the recessed groove 48, the dividing blade 70 reaches the intersecting part with the retainer guide groove 44. In this way, the dividing blade 70 is easily brought into contact with the retainer side portion 56 located in the retainer guide groove 44.

Further, a surface located on a side distant from the cavity exposing recess 40 with respect to the retainer guide groove 44 is a part of a side surface 48a of the recessed groove 48 on the side distant from the cavity exposing recess 40. This side surface 48a extends along the extension direction of the cavities 34 and is facing the tip of the retainer side portion 56 to be described later.

The retainer 50 includes a retainer body 52, a pair of the retainer side portions 56 and the mating locking portions 58.

The retainer body 52 is arranged in the cavity exposing recess 40 to hold the terminals 20 in the cavities 34. In this embodiment, the retainer body 52 includes a plurality of terminal holding portions 52a, 52b to correspond to the respective rows of the cavities 34. The terminal holding portion 52a is a part for holding the terminals 20 in the cavities 34 on a side near the opening of the cavity exposing recess 40. The terminal holding portion 52b is a part for holding the terminals 20 in the cavities 34 arranged on an inner side of the cavity exposing recess 40. Each terminal holding portion 52a, 52b is in the form of a long plate, which can be arranged in the cavity exposing recess 40 over the entire cavity exposing recess 40 in the extension direction, i.e. the entire rectangular parallelepiped part 33 in a width direction. Widths of the terminal holding portions 52a, 52b are equal to that of the cavity exposing recess 40, and the terminal holding portions 52a, 52b are accommodated into the cavity exposing recess 40 and positioned in a front-rear direction of the connector housing 30.

An outward facing surface 52f of the retainer body 52 (outward facing surface of the terminal holding portion 52a) is a flat surface. With the retainer 50 mounted in the housing body 32, a principal surface 32f1 on the one side in the thickness direction of the housing body 32 is located on an extension of the outward facing surface 52f of the retainer body 52. The principal surface 32f1 on the one side in the thickness direction of the housing body 32 is preferably a surface including no protrusion projecting from the outward facing surface 52f of the retainer body 52.

Parts of the terminal holding portion 52a, 52b facing the inner side of the cavity exposing recess 40 are formed to protrude into the cavities 34 to be able to enter the recesses between the mating connecting portions 22 and the wire connecting portions 24 of the terminals 20 arranged in the cavities 34. Inward facing parts of the terminal holding portion 52a, 52b project into the cavities 34 and enter the recesses between the mating connecting portions 22 and the wire connecting portions 24 of the terminals in the cavities 34, whereby the terminals 20 are held at fixed positions in the cavities 34. In this state, the retainer body 52 is fit in the cavity exposing recess 40. If an attempt is made to move the terminal 20 in the extension direction thereof, this force is received by both front and rear surfaces of the cavity exposing recess 40 via the retainer body 52.

With the retainer 50 located just before the innermost side of the cavity exposing recess 40, the terminal holding portions 52a, 52b can be prevented from protruding into the cavities 34. In this temporarily mounted state, the terminal 20 can enter the cavity 34 without interfering with the terminal holding portion 52a, 52b of the retainer 50 and can be pulled out from the cavity 34.

A wall partitioning between the adjacent cavities 34 may be formed between the terminal holding portions 52a, 52b. In this way, the terminals 20 accommodated in the cavities 34 on the side near the opening of the cavity exposing recess 40 can be partitioned by this wall. The terminals accommodated in the cavities 34 on the inner side of the cavity exposing recess 40 may be partitioned by a wall formed in the housing body 32 itself.

The pair of retainer side portions 56 are formed to extend toward the pair of locking portions 46 from both side parts of the retainer body 52. In this embodiment, the pair of retainer side portions 56 are formed to extend along the retainer guide grooves 44. In this embodiment, the retainer side portion 56 is in the form of a rectangular plate having a constant width. A width of the retainer side portion 56 is set to be equal to that of the retainer side portion 56 to such an extent that the retainer side portion 56 is accommodated into the retainer guide groove 44. In this embodiment, the width of the retainer side portion 56 is larger than that of the retainer body 52 in a front-rear direction of the housing body 32.

A length of the retainer side portion 56 is set in such a size that a tip part of the retainer side portion 56 reaches a position just before the side surface 48a of the recessed groove 48 with the retainer body 52 arranged in the cavity exposing recess 40.

The inward facing surface of the tip part of the retainer side portion 56 is formed into a guide surface 56g extending outward toward a tip side. When the retainer side portion 56 is moved in and along the retainer guide groove 44, the guide surface 56g contacts the locking portion 46, whereby the retainer side portion 56 is easily resiliently deformable outward.

Since the tip part of the retainer side portion 56 reaches a position just before the side surface 48a of the recessed groove 48, a state where a surrounding member contacts the guide surface 56g and inadvertently deforms the retainer side portion 56 outward hardly occurs.

The side surface 48a is preferably formed at a position spaced apart from the tip of the retainer side portion 56. As described above, it is supposed that, when the dividing blade 70 cuts into the retainer side portion 56, a divided part is pushed away by a thickness of the dividing blade 70. It is possible to secure a retraction space for the divided part by a gap S between the side surface 48a and the tip of the retainer side portion 56.

The pair of retainer side portions 56 are respectively formed with a pair of the mating locking portions 58 lockable to the locking portions 46. In this embodiment, the mating locking portion 58 is a recess to be locked to the locking portion 46, which is a protrusion. More specifically, the mating locking portion 58 in the form of a recessed groove extending along an extension direction of the retainer side portion 56 is formed in the inward facing surface of the retainer side portion 56. A tip part of the mating locking portion 58 reaches a position just before the tip part of the retainer side portion 56. In the tip part of the mating locking portion 58, a surface facing the retainer body 52 is a locking surface 58f lockable to the locking portion 46.

Note that the mating locking portions 58 extend toward the base ends of the pair of retainer side portions 56 and penetrate through the retainer body 52. In this way, the groove-shaped mating locking portions 58 are easily molded. It is not essential that the mating locking portions 58 reach the base ends of the pair of retainer side portions 56.

The retainer side portion 56 can be locked to the locking portion 46 while being arranged in the retainer guide groove 44. With the retainer 50 mounted in the connector housing 30, both outward facing side surfaces 32f2 of the housing body 32 are located on extensions of the outward facing surfaces 56f of the retainer side portions 56. The side surface 32f2 of the housing body 22 is preferably a surface including no protrusion projecting from the outward facing surface 56f of the retainer side portion 56.

Each of the pair of retainer side portions 56 is formed with dividing recesses 57 in the extension direction of the cavities 34. That is, the dividing recess 57 is a recess recessed rearward from the front edge of the retainer side portion 56 or recessed forward from the rear edge. In this embodiment, each of the pair of retainer side portions 56 is formed with the dividing recess 57 recessed rearward from the front edge and the dividing recess 57 recessed forward from the rear edge.

The dividing recess 57 is a recess for promoting the division of the retainer side portion 56 into a plurality of pieces in the extension direction. The dividing recess 57 may be grasped as a recess for partially weakening the retainer side portion 56 in the extension direction for easier division, a recess for guiding the blade for dividing the retainer side portion 56 or a recess triggering the division of the retainer side portion 56.

Note that, when the locking portion 46 and the mating locking portion 58 are locked, the retainer side portion 56 is resiliently deformed in the thickness direction. Since the dividing recess 57 is a recess recessed in the extension direction of the cavities 34, the retainer side portion 56 is hardly divided from the dividing recess 57 when being resiliently deformed in the thickness direction.

The shape of the dividing recess 57 is arbitrary. In this embodiment, the dividing recess 57 is formed into a V-shaped recess recessed from the edge of the retainer side portion 56. Thus, the dividing blade 70 is guided by the deepest trough bottom part of the dividing recess 57. Thus, the dividing blade 70 is in contact with the retainer side portion 56 at a fixed position and the divided part of the retainer side portion 56 is stable.

The dividing recess may be a U-shaped groove or a rectangular groove having a bottom perpendicular to a groove depth direction.

The dividing recess 57 is formed on a side closer to the base end than the locking surface 58f in the retainer side portion 56. Thus, if the retainer side portion 56 is divided on an extension of the dividing recess 57, the tip part of the retainer side portion 56 having the locking surface 58f is divided from a part on the base end side. Thus, the other part of the retainer 50 can be divided from the tip part having the locking surface 58f capable of contacting the locking portion 46, and the retainer 50 can be set in the temporarily mounted state. In this way, the terminal holding portions 52a, 52b are retracted from the respective cavities 34 and the terminals 20 can be pulled out from the respective cavities 34.

The dividing recess 57 is preferably located in the recessed groove 48. If the dividing recess 57 is located in the recessed groove 48, the dividing blade 70 is easily guided into the dividing recess 57, using the recessed groove 48. The dividing recess 57 is preferably located closer to a side surface 48c facing the side surface 48a than the side surface 48a in the recessed groove 48. If the dividing recess 57 is located close to the side surface 48a in the recessed groove 48, the dividing blade 70 is easily pushed into contact with a part of the retainer side portion 56 closer to the base end side than the locking surface 58f.

Further, the dividing recess 57 may be located away from the side surface 48c by a predetermined distance. The predetermined distance may be a distance between a surface capable of contacting the side surface 48c and a cutting edge of the dividing blade 70 in the thickness direction of the dividing blade 70. In this way, if the above surface of the dividing blade 70 is brought into contact with the side surface 48c and slid, the cutting edge of the dividing blade 70 can be guided into the dividing recess 57.

In this connector 10, the terminal 20 is held in the cavity 34 by inserting the terminal 20 into the cavity 34 with the retainer 50 temporarily mounted in the connector housing 30. In the mounted state of the retainer 50, the locking portions 46 of the connector housing 30 are locked to the mating locking portions 58 of the retainer 50. Further, an inward facing part of the retainer body 52 is inserted in the cavities 34 and the recesses between the mating connecting portions 22 and the wire connecting portions 24 of the terminals 20 in the cavities 34.

Towards decarbonization, it is requested to improve recyclability for in-vehicle components to be installed in a vehicle. The connector 10 is an example of a component applicable as an in-vehicle component. It is requested for the connector 10 to easily and quickly disassemble the terminals 20 made of metal and the connector housing 30 made of resin for the improvement of recyclability.

It is requested for the connector 10 to lift the retainer 50 from the connector housing 30 and enable a hooked sate of the retainer body 52 to the terminals 20 in the cavities 34 to be quickly released. This is because the terminals 20 can be pulled out from the cavities 34 and the connector 10 can be easily disassembled, such as by pulling the wires 28, if the hooked state of the retainer 50 to the terminals 20 can be released. Note that it is sufficient to disassemble the connector 10 at least into the connector housing 30, which is a resin part, and the terminals 20, and the connector housing 30 may not be disassembled into the housing body 32 and the retainer 50.

In this connector 10, the retainer 50 can be set in a state similar to the temporarily mounted state by dividing the retainer side portions 56, utilizing the dividing recesses 57. In this way, the terminals 20 can be easily separated from the connector housing 30.

### <Connector Disassembly Tool>

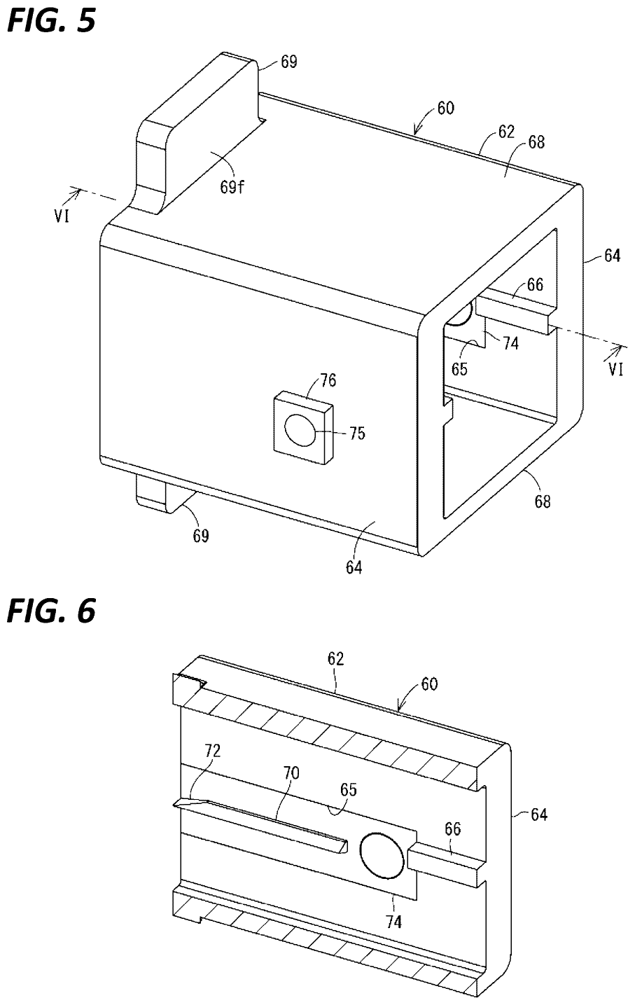

A connector disassembly tool 60 applicable to the disassembly of the connector 10 is described below. FIG. 5 is a perspective view showing the connector disassembly tool 60. FIG. 6 is a perspective view in section along VI-VI of FIG. 5.

The connector disassembly tool 60 is a tool for releasing the locked state of the retainer 50 to the housing body 32 and provided with a pair of the dividing blades 70 and a disassembly tool body 62. The dividing blade 70 is preferably a blade made of a hard material such as a metal blade or a ceramic blade. The disassembly tool body 62 may be, for example, a resin molded article or may be made of metal.

The dividing blade 70 is a blade including a cutting edge 72. In this embodiment, the dividing blade 70 is formed into an elongated shape. One end in an extension direction of the dividing blade 70 is formed into the cutting edge 72 gradually thinned toward a tip. In this embodiment, the cutting edge 72 is double-edged by being inclined on both surface sides. The cutting edge may be single-edged by being inclined only on one surface side.

Although the dividing blade 70 is shaped to be gradually thinner toward one side in a width direction in this embodiment, this is not essential.

The other end part in the width direction of the dividing blade 70 is supported by a base member 74. In this embodiment, the base member 74 is in the form of a rectangular plate. The dividing blade 70 is supported in a projecting state on one principal surface of the base member 74. The dividing blade 70 and the base member 74 may be integrally formed, such as by metal cutting, or may be united by welding, screwing or the like. A screw shaft portion 75 projects on the other principal surface of this base member 74. The screw shaft portion 75 is integrated with the base member 74, for example, by being inserted into a hole formed in the base member 74.

The disassembly tool body 62 supports the pair of dividing blades 70 such that the pair of dividing blades 70 are held in parallel while being spaced apart by a distance corresponding to a width between a pair of locking parts of the retainer 50 to the both side parts of the housing body 32 (locking portions 46 and mating locking portions 58).

More specifically, the disassembly tool body 62 is in the form of a rectangular tube including a pair of side wall portions 64 and coupling wall portions 68 coupling both side edges of the pair of side wall portions 64.

The dividing blade 70 is supported on each of the pair of side wall portions 64. In this embodiment, the dividing blade 70 is exchangeably supported on the side wall portion 64.

That is, a blade supporting recess 65, into which the base member 74 is fit, is formed in an inward facing part of each of the pair of side wall portions 64. The blade supporting recess 65 is formed into a rectangular parallelepiped recess extending along a direction connecting both openings of the disassembly tool body 62 in an intermediate part between both side edges of the side wall portion 64. The base member 74 is fit into the blade supporting recess 65 to cause the dividing blade 70 to project from the disassembly tool body 62. In this state, the inner surface of the side wall portion 64 and the inner surface of the base member 74 are preferably located on the same plane.

The side wall portion 64 is formed with a screw insertion hole, and the screw shaft portion 75 projects to the outside of the side wall portion 64 through this screw insertion hole. A part of the screw shaft portion 75 projecting on the outer surface of the side wall portion 64 is threadably engaged with a nut 76. In this way, the base member 74 including the dividing blade 70 is mounted on the side wall portion 64. If the nut 76 is removed, the base member 74 can be removed from the blade supporting recesses 65 and the dividing blade 70 can be removed. The dividing blade 70 can be exchanged by fitting a base member 74 including another dividing blade 70 into the blade supporting recess 65 and threadably engaging a screw shaft portion 75 of this base member 74 with the nut 76.

It is not essential that the dividing blade 70 is exchangeable in the disassembly tool body 62. The dividing blade 70 may be integrally formed to the disassembly tool body 62, such as by cutting.

Guide protrusions 66 are provided to project on extensions of the dividing blades 70 on the pair of side wall portions 64. The guide protrusion 66 is, for example, a rectangular parallelepiped protrusion. A width of the guide protrusion 66 may be a width obtained by subtracting the thickness of the dividing blade 70 from the width of the recessed groove 48. The guide protrusion 66 can move along the recessed groove 48 while being guided by the recessed groove 48. The guide protrusion 66 is located on a side opposite to the cutting edge 72 with respect to the dividing blade 70. The guide protrusion 66 can contact the side surface 48a of the recessed groove 48 and guide the dividing blade 70 by entering the recessed groove 48, following the dividing blade 70. Further, if the width of the guide protrusion 66 is the width obtained by subtracting the thickness of the dividing blade 70 from the width of the recessed groove 48, the guide protrusion 66 easily passes in the recessed groove 48 without interfering with a part of the retainer side portion 56 not to be cut.

A pair of the coupling wall portions 68 couple both side parts of the pair of side wall portions 64. The pair of coupling wall portions 68 and the pair of side wall portions 64 are formed into a shape to surround at least a part of the periphery of the housing body 32 while avoiding interference with the housing body 32 when the pair of dividing blades 70 move along the both side parts of the housing body 32.

In this embodiment, the pair of side wall portions 64 are facing a pair of the side surfaces 32f2 of the housing body 32. An interval between the pair of side wall portions 64 is set such that the pair of side wall portions 64 can restrict a position in the width direction of the housing body 32 by contacting the pair of side surfaces 32f2, e.g. set to be slightly larger than an interval between the pair of side surfaces 32f2 of the housing body 32.

One coupling wall portion 68 is facing the principal surface 32f1 of the housing body 32 with the pair of dividing blades 70 cut in the dividing recesses 57. The other coupling wall portion 68 is facing a surface of the housing body 32 opposite to the principal surface 32f1, here, an outward facing surface of the surrounding portion 37 with the pair of dividing blades 70 cut in the dividing recesses 57. An interval between the pair of coupling wall portions 68 is set such that the pair of coupling wall portions 68 can restrict a position in the thickness direction of the housing body 32 by contacting surfaces on both sides in the thickness direction of the housing body 32, e.g. set to be slightly larger than a dimension in the thickness direction of the housing body 32.

If the housing body 32 includes a part projecting from the principal surface 32fl or the side surface 32f2, an inward facing part of the disassembly tool body may include a recess for avoiding this projecting part.

It is not essential that the disassembly tool body 62 surrounds the housing body 32 over the entire periphery. For example, one of the pair of coupling wall portions may be omitted.

In this embodiment, the connector disassembly tool 60 is further provided with grip portions 69 projecting outward from the disassembly tool body 62. More specifically, the grip portions 69 project outward from the pair of coupling wall portions 68. The grip portion 69 is in the form of a plate orthogonal to the extension direction of the dividing blades 70. Thus, the grip portion 69 has a surface 69f extending in a direction orthogonal to the extension direction of the dividing blades 70. A worker easily applies a force for moving the connector disassembly tool 60 with respect to the connector 10 by applying a force to the grip portions 69.

It is not essential that the grip portions 69 are shaped as described above. A grip portion may be an elongated bar-like handle easily gripped by the worker. That is, the grip portion only has to be a part for holding the connector disassembly tool 60 at a fixed position or receiving a moving force with respect to the connector 10 by projecting from the disassembly tool body 62.

It is not essential that the connector disassembly tool 60 includes the grip portions.

Conceivably, the connector 10 itself is small (e.g. a width of about 10 mm to 15 mm) and, accordingly, the disassembly tool body 62 itself is also small. In such a case, by providing the connector disassembly tool 60 with the grip portions 69, the connector disassembly tool 60 is easily moved with respect to the connector 10. In this way, the disassembly operation of the connector 10 can be easily performed.

### <Disassembly Operation of Connector>

An operation example of disassembling the connector 10 using the connector disassembly tool 60 is described.

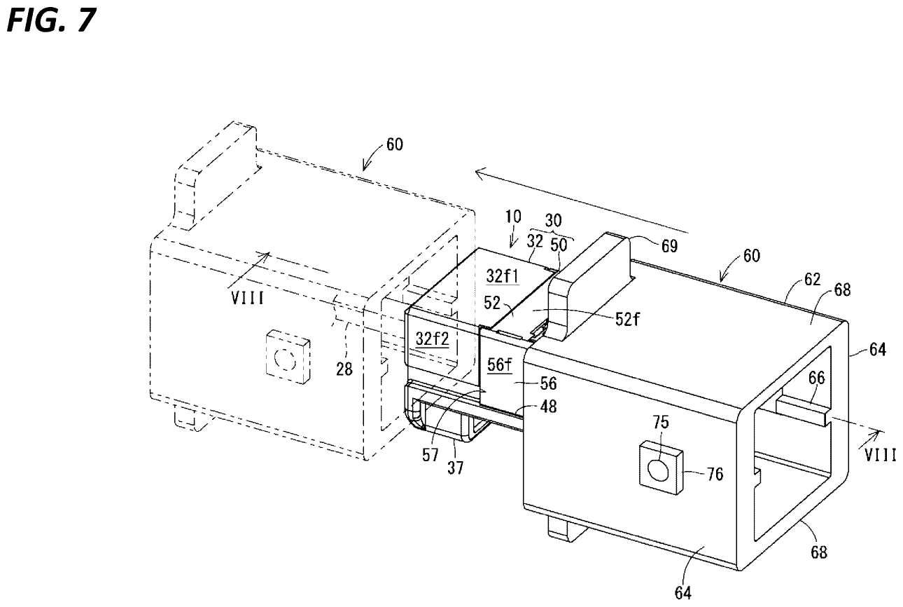

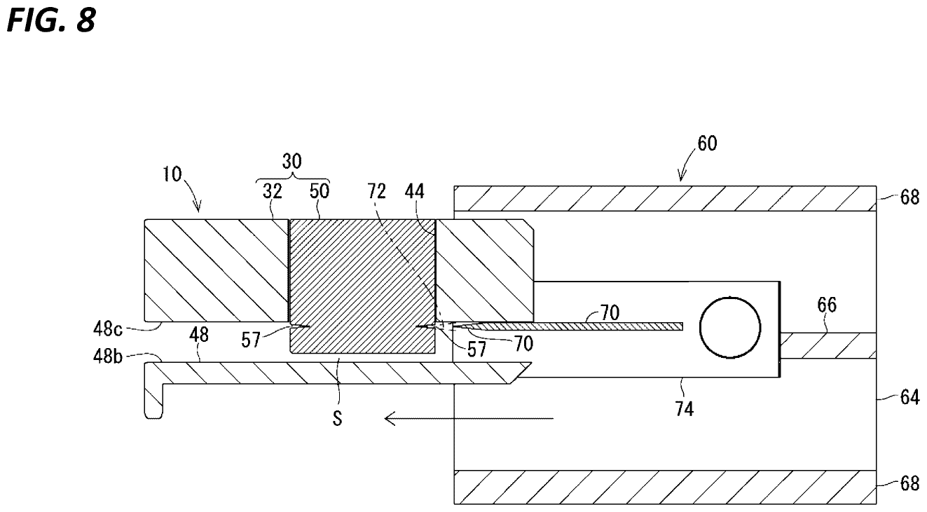

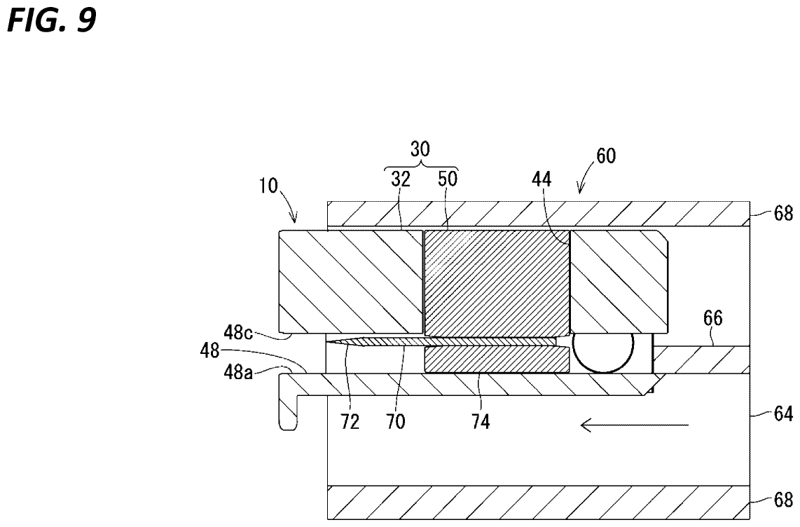

FIG. 7 is a view showing the disassembly operation. FIG. 7 shows a state where the connector 10 is passing through the inside of the connector disassembly tool 60. FIGS. 8 and 9 are diagrams in section along VIII-VIII of FIG. 7 showing a dividing operation of the dividing blade 70.

First, as shown in FIG. 7, the connector 10 to be disassembled is prepared. The terminal 20 is accommodated in each cavity 34 of the connector 10. It is thought that the retainer body 52 is inserted in the recesses between the mating connecting portions 22 and the wire connecting portions 24 and the resilient locking pieces 32P are hooked to the locking holes 22h of the mating connecting portions 22. The wire 28 having the terminal 20 crimped to the end part thereof extends out to the rear end side of the housing body 32 from the cavity 34.

The housing body 32 is pushed into the connector disassembly tool 60 from front. Then, the pair of dividing blades 70 enter the pair of recessed grooves 48. The pair of dividing blades 70 move toward the retainer side portions 56 along the pair of recessed grooves 48 with the housing body 32 guided by the inner surface of the disassembly tool body 62 and the pair of dividing blades 70 guided by the pair of recessed grooves 48.

As shown in FIG. 8, the dividing blades 70 approach the pair of retainer side portions 56 and enter the dividing recesses 57. If the dividing recess 57 is a V-shaped groove, the cutting edge 72 of the dividing blade 70 is guided toward the innermost point of the V shape by the inclined surfaces of the V-shaped groove. Thus, the cut starting position of the cutting edge 72 is stabilized with respect to the retainer side portion 56.

As cutting into the retainer side portion 56, the dividing blade 70 enters between a tip part of the retainer side portion 56 including the locking surface 58f and a part of the retainer side portion 56 remaining on the base end side as shown in FIG. 9. The divided tip part of the retainer side portion 56 is pushed away toward the side surface 48a by the thickness of the dividing blade 70 in the recessed groove 48.

If an interval equal to or larger than the thickness of the dividing blade 70 is provided between the tip of the retainer side portion 56 before being divided and the side surface 48a, a retraction space for the divided tip part of the retainer side portion 56 can be secured and the dividing blade 70 can smoothly cut into the retainer side portion 56.

The dividing blades pass through the retainer side portions 56 and the connector 10 comes out from the connector disassembly tool 60. Note that the tip parts of the retainer side portions 56 remaining in the recessed grooves 48 can be pushed away and removed by moving the guide protrusions 66 in the recessed grooves 48 after the dividing blades pass through the retainer side portions 56.

Since the retainer body 52 is divided from the tip parts of the retainer side portions 56 including the locking surfaces 58f in the above state, the retainer body 52 can move in a direction separating from the cavities 34. In this way, a state of holding the terminals 20 by the retainer body 52 can be released and the terminals 20 can be pulled out from the cavities 34, such as by pulling the wires 28. If the terminals 20 are pulled out from the cavities 34, the retainer 50 can also be separated from the housing body 32.

Note that since the dividing recesses 57 are formed on both sides of the retainer side portions 56, the operation of dividing the retainer side portions 56 by the dividing blades 70 can be performed even if the connector 10 is inserted into the connector disassembly tool 60 in a direction opposite to the above direction. That is, the disassembly operation of the connector 10 can be performed regardless of the insertion direction of the connector 10 into the connector disassembly tool 60.

### Effects, Etc.

According to the connector 10 configured as described above, since each of the pair of retainer side portions 56 is formed with the dividing recesses 57 recessed in the extension direction of the cavities 34, the retainer side portions 56 can be easily divided, utilizing the dividing recesses 57. By dividing the retainer side portions 56, the retainer body 52 can be separated from the locking parts of the locking portions 46 and the mating locking portions 58 and moved in the direction separating from the housing body 32. In this way, the state of holding the terminals 20 by the retainer 50 is easily released and the terminals 20 are easily separated from the housing body 32.

If the dividing recess 57 is formed into a V-shaped recess, the cutting edge 72 of the dividing blade 70 is easily guided to the fixed position of the dividing recess 57. In this way, the retainer side portion 56 is easily and stably divided at the fixed position.

Further, since the dividing recesses 57 are formed in the both side edges of the retainer side portion 56, the retainer side portion 56 can be divided from either one of the edges of the retainer side portion 56, utilizing the dividing recess 57, and workability is excellent.

Further, since the gap S is provided between the side surface 48a of the recessed groove 48 and the tip of the retainer side portion 56, the divided tip part of the retainer side portion 56 can move to fill the gap S after the dividing blade 70 cuts into the retainer side portion 56. Thus, the dividing blade 70 can easily enter between divided parts of the retainer side portion 56 and the retainer side portion 56 can be easily divided.

Further, since the housing body 32 has the principal surface 32f1 located on the extension of the outward facing surface 52f of the retainer body 52 and the pair of side surfaces 32f2 located on the extensions of the outward facing surfaces 56f of the retainer side portions 56 in the mounted state of the retainer 50, the connector disassembly tool 60 for removing the retainer 50 is easily handled outside the principal surface 32f1 and the pair of side surfaces 32f2.

Further, according to the connector disassembly tool 60 configured as described above, the pair of dividing blades 70 can be moved toward the coinciding locking parts or parts near the locking parts of the retainer 50 along the both side parts of the housing body 32. By dividing the pair of locking parts or the parts near the locking parts of the retainer by the pair of dividing blades 70, the retainer 50, particularly the retainer 52, can be moved in the direction separating from the housing body 32. In this way, the state of holding the terminals 20 by the retainer body 52 can be released and the terminals 20 can be disassembled from the housing body 32.

Further, since the pair of dividing blades 70 are exchangeably supported on the disassembly tool body 62, the dividing blade 70 can be exchanged, such as when the dividing blade 70 is worn.

Further, since the disassembly tool body 62 is shaped to surround at least a part of the periphery of the housing body 32 while avoiding interference with the housing body 32 when the pair of dividing blades 70 move along the both side parts of the housing body 32, the pair of dividing blades 70 are easily collectively moved toward the pair of locking parts or the parts near the locking parts. An operation of collectively dividing the pair of locking parts or the parts near the locking parts of the retainer 50 by the pair of dividing blades 70 can be easily performed.

Further, since the connector disassembly tool 60 includes the grip portions 69 projecting from the disassembly tool body 62, a force is easily applied to the connector disassembly tool 60. In this way, the disassembly operation of the connector 10 utilizing the connector disassembly tool 60 can be easily performed.

Note that the respective components described in the above embodiment and each modification can be appropriately combined as long as those do not contradict each other.

### LIST OF REFERENCE NUMERALS

10 connector
20 terminal
22 mating connecting portion
22h locking hole
23 coupling portion
24 wire connecting portion
28 wire
30 connector housing
32 housing body
32P resilient locking piece
32f1 principal surface of housing body
32f2 side surface of housing body
33 rectangular parallelepiped part
34 cavity
34a opening
35 connector connecting locking piece
36 operating portion
37 surrounding portion
40 cavity exposing recess
44 retainer guide groove
44b bottom surface of retainer guide groove
46 locking portion
47 auxiliary locking portion
48 recessed groove
48a, 48c side surface of recessed groove
48b bottom surface
50 retainer
52 retainer body
52a, 52b terminal holding portion
52f outward facing surface of retainer body
56 retainer side portion
56f outward facing surface of retainer side portion
56g guide surface
57 dividing recess
58 mating locking portion
58f locking surface
60 connector disassembly tool
62 disassembly tool body
64 side wall portion
65 blade supporting recess
66 guide protrusion
68 coupling wall portion
69 grip portion
69f surface of grip portion
70 dividing blade
72 cutting edge
74 base member
75 screw shaft portion
76 nut
S gap between tip of retainer side portion and side surface of recessed groove

1. A connector, comprising:
a terminal; and
a connector housing including a housing body having a cavity extending from one end toward the other end and a retainer to be removably mounted into the housing body, the terminal being accommodated into the cavity,
the housing body including a cavity exposing recess for exposing an intermediate part in an extension direction of the cavity to outside and a pair of locking portions formed on both side parts of the housing body,
the retainer including a retainer body to be arranged in the cavity exposing recess to hold the terminal in the cavity, a pair of retainer side portions extending from both side parts of the retainer body toward the pair of locking portions and a pair of mating locking portions respectively formed on the pair of retainer side portions and lockable to the locking portions, and
a dividing recess recessed in the extension direction of the cavity is formed in each of the pair of retainer side portions.

2. The connector of claim 1, wherein the dividing recess is formed into a V shape recessed from at least one of edges of the retainer side portion on one end side and the other end side of the housing body.

3. The connector of claim 1, wherein the dividing recesses are formed in the both edges of the retainer side portion on the one end side and the other end side of the housing body.

4. The connector of claim 1, wherein a recessed groove extending from a position where the dividing recess is arranged to at least one of one end and the other end of the housing body is formed in each of the both side parts of the housing body.

5. The connector of claim 4, wherein:
the recessed groove has a side surface facing a tip of the retainer side portion and extending along the extension direction of the cavity, and
the side surface is formed at a position spaced apart from the tip of the retainer side portion.

6. The connector of claim 1, wherein the housing body has a principal surface located on an extension of an outward facing surface of the retainer body and a pair of side surfaces located on extensions of outward facing surfaces of the pair of retainer side portions in a mounted state of the retainer.

7. A connector disassembly tool for releasing a locked state of a retainer to a housing body, comprising:
a pair of dividing blades; and
a disassembly tool body for supporting the pair of dividing blades such that the pair of dividing blades are held in parallel while being spaced apart by a distance corresponding to a width between a pair of locking parts of the retainer to both side parts of the housing body.

8. The connector disassembly tool of claim 7, wherein the pair of dividing blades are exchangeably supported on the disassembly tool body.

9. The connector disassembly tool of claim 7, wherein the disassembly tool body is formed into a shape to surround at least a part of a periphery of the housing body while avoiding interference with the housing body when the pair of dividing blades move along the both side parts of the housing body.

10. The connector disassembly tool of claim 7, further comprising a grip portion projecting from the disassembly tool body.
